(19) United States
(12) Patent Application Publication
(10) Pub. No.: US 2026/0184310 A1
(43) Pub. Date: Jul. 2, 2026

(54) REVERSE CONTROL SYSTEM AND METHOD IN TOW MODE OF ECO-FRIENDLY VEHICLE

(71) Applicants: HYUNDAI MOTOR COMPANY, SEOUL (KR); KIA CORPORATION, SEOUL (KR)

(72) Inventor: Seunghyun Kim, Hwaseong-si (KR)

(73) Assignees: HYUNDAI MOTOR COMPANY, SEOUL (KR); KIA CORPORATION, SEOUL (KR)

(21) Appl. No.: 19/290,693

(22) Filed: Aug. 5, 2025

(30) Foreign Application Priority Data
Dec. 31, 2024 (KR) 10-2024-0201510

(51) Int. Cl. B60W 30/18; B60W 10/08; B60W 10/184; B60W 10/20

(52) U.S. Cl. CPC B60W 30/18036; B60W 10/08; B60W 10/184; B60W 10/20; B60W 2300/14; B60W 2540/10; B60W 2540/12; B60W 2540/18

(57) ABSTRACT

A reverse control system in a tow mode of an eco-friendly vehicle, including a first vehicle controller mounted in a towing vehicle, a second vehicle controller mounted in a towed vehicle, and a connector provided between the towing vehicle and the towed vehicle to allow towing and communication therebetween, in which the first vehicle controller is configured to transmit a braking signal, a reverse signal, a steering angle signal and a reverse driving signal of the towing vehicle to the second vehicle controller through the connector, and the second vehicle controller is configured to perform steering control and reverse driving power control of the towed vehicle based on the reverse signal, the steering angle signal and the reverse driving signal of the towing vehicle or to perform braking control of the towed vehicle based on the braking signal of the towing vehicle.

### CROSS REFERENCE TO RELATED APPLICATIONS

This application claims, under 35 U.S.C. §119(a), the benefit of and priority to Korean Patent Application No. 10-2024-0201510 filed on December 31, 2024, the entire contents of which are incorporated herein by reference.

### BACKGROUND

### (a) Technical Field

The present disclosure relates to a reverse control system in a tow mode of an eco-friendly vehicle and a method therefore, and more specifically, to a backward driving control system in a tow mode of an eco-friendly vehicle and a method therefore, which allows steering control of a towed vehicle in reverse of a towing vehicle and reverse driving power control, thereby ensuring smooth reversing of the towing vehicle and the towed vehicle.

### (b) Background Art

As is well known, an eco-friendly vehicle may include a hybrid vehicle that uses an engine and a motor as driving sources, an electric vehicle that uses a motor as a driving source, a fuel cell vehicle, and the like.

In a case where a user wants to use two eco-friendly vehicles at a desired destination, the user may use a towing function to bring the two eco-friendly vehicles to the desired destination. This function is called a tow mode.

For example, one vehicle may serve as a towing vehicle for actual driving, and the other vehicle may serve as a towed vehicle connected to the rear of the towing vehicle by a connector that is a predetermined tow bar, so that the two vehicles can be brought to the desired destination.

FIGS. 1 and 2 are schematic diagrams showing a state in which a conventional towing vehicle is towing a towed vehicle in reverse.

As shown in FIGS. 1 and 2, in order for a towing vehicle 100 to tow a towed vehicle 200 to their destination, the towing vehicle 100 and the towed vehicle 200 are connected to each other by a connector 300 for towing and communication.

To this end, the towing vehicle 100 and the towed vehicle 200 may be communicably connected to each other by the connector 300 including a cable for CAN communication, and a vehicle controller of the towing vehicle 100 and a vehicle controller of the towed vehicle 200 may be connected to each other for data transmission and reception by the cable for CAN communication included in the connector 300.

Here, a regenerative braking condition command signal may be transmitted from the vehicle controller of the towing vehicle 100 to the vehicle controller of the towed vehicle 200 through the cable for CAN communication included in the connector 300, and information on a battery charge state due to the regenerative braking may be transmitted from the vehicle controller of the towed vehicle 200 to the vehicle controller of the towing vehicle 100.

Thus, in a case where the towing vehicle 100 is towing the towed vehicle 200 to the destination in a state where the towing vehicle 100 and the towed vehicle 200 are connected by the connector 300, a tow charge mode (also referred to as an EV flat tow mode) in which regenerative braking of a motor mounted in the towed vehicle 200 is performed and a high voltage battery is charged using power generated by the regenerative braking through an inverter may be performed.

However, in a case where the towing vehicle 100 is in reverse by steering operation and reverse driving power in a state where the towing vehicle 100 and the towed vehicle 200 are connected by the connector 300, steering and reverse driving of the towed vehicle 200 are not performed, thereby causing the driver difficulty when reversing in a narrow space, and the connector 300 that connects the towing vehicle 100 and the towed vehicle 200 may be damaged.

For example, in a case where the towing vehicle 100 is steered in a clockwise direction and is in reverse by the reverse driving power, the rear part of the towing vehicle 100 moves in a counter-clockwise direction, and at the same time, the rear part of the towed vehicle 200 moves in a clockwise direction, as shown in FIG. 1, which causes the driver to have difficulty reversing in the narrow space.

Furthermore, in a case where the reversing continues by the reverse driving power with the towing vehicle 100 having a steering angle greater than a predetermined angle in a clockwise direction, as shown in FIG. 2, the rear part of the towing vehicle 100 moves in the counterclockwise direction excessively, and at the same time, the rear part of the towed vehicle 200 moves in the clockwise direction excessively, so that an angle between the rear part of the towing vehicle 100 and the front part of the towed vehicle 200 may be excessively widened, thereby causing the connector 300 connected between the towing vehicle 100 and the towed vehicle 200 to be broken or damaged.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to solve the above-described problems associated with prior art, and an object of the present disclosure is to provide a reverse control system in a tow mode of an eco-friendly vehicle and a method therefore, capable of performing steering control and reverse driving power control of a towed vehicle in a case where a towing vehicle is in reverse by reverse driving power during steering in a state where the towing vehicle and the towed vehicle are connected to each other by a connector for towing and communication, to facilitate smooth reversing of the towing vehicle and the towed vehicle and prevent the connector from being broken or damaged.

In one aspect, the present disclosure provides a reverse control system in a tow mode of an eco-friendly vehicle, including a first vehicle controller mounted in a towing vehicle, a second vehicle controller mounted in a towed vehicle, and a connector provided between the towing vehicle and the towed vehicle to allow towing and communication, in which the first vehicle controller is configured to transmit a braking signal, a reverse signal, a steering angle signal and a reverse driving signal of the towing vehicle to the second vehicle controller through the connector, and the second vehicle controller is configured to perform steering control and reverse driving power control of the towed vehicle based on the reverse signal, the steering angle signal and the reverse driving signal of the towing vehicle or to perform braking control of the towed vehicle based on the braking signal of the towing vehicle.

In an embodiment, the system may further include a gearshift that provides the reverse signal of the towing vehicle to the first vehicle controller, a steering angle sensor that provides the steering angle signal of the towing vehicle to the first vehicle controller, an accelerator position sensor that provides the reverse driving signal of the towing vehicle to the first vehicle controller, a brake position sensor that provides the braking signal of the towing vehicle to the first vehicle controller, a shift controller that controls a reverse gear of the towed vehicle according to a command of the second vehicle controller, a steering controller that controls a steering angle of the towed vehicle according to a command of the second vehicle controller, a motor controller that applies a reverse driving power of the towed vehicle to a motor according to a command of the second vehicle controller, and a brake controller that operates a brake system of the towed vehicle according to a command of the second vehicle controller.

In another embodiment, the second vehicle controller may be configured to transmit reverse shift of the towed vehicle to the shift controller based on the reverse signal of the gearshift transmitted from the first vehicle controller.

In still another embodiment, the second vehicle controller may be configured to transmit a steering angle signal corresponding to the steering angle in reverse of the towing vehicle to the steering controller based on the steering angle signal of the steering angle sensor transmitted from the first vehicle controller.

In yet another embodiment, the second vehicle controller may be configured to transmit a control signal for reversing of the towed vehicle to the motor controller based on an accelerator depression detection signal of the accelerator position sensor transmitted from the first vehicle controller.

In still yet another embodiment, the second vehicle controller may be configured to transmit a braking command signal of the towed vehicle to the brake controller based on a detection signal of the brake position sensor transmitted from the first vehicle controller.

In a further embodiment, the system may further include a first rear-view camera and a first around-view parking assist sensor provided in the towing vehicle, a second rear-view camera and a second around-view parking assist sensor provided in the towed vehicle, and an around-view controller configured to receive an imaging signal from the first rear-view camera and a detection signal from the first around-view parking assist sensor through the first vehicle controller and receive an imaging signal from the second rear-view camera and a detection signal from the second around-view parking assist sensor through the second vehicle controller, the connector, and the first vehicle controller, to display an around-view of the towing vehicle and an around-view of the towed vehicle as one integrated view on a display.

In another further embodiment, the system may further include an auto hold button that outputs a select signal or a release signal of a reverse control mode of the towed vehicle to the first vehicle controller when pressed for a set time.

In another aspect, the present disclosure provides a reverse control method in a tow mode of an eco-friendly vehicle, including connecting a towing vehicle and a towed vehicle for towing and communication, by a connector, determining whether a reverse control mode of the towed vehicle is selected by a first vehicle controller of the towing vehicle, transmitting, in a case where the reverse control mode of the towed vehicle is selected, a braking signal, a reverse signal, a steering angle signal and a reverse driving signal of the towing vehicle from the first vehicle controller of the towing vehicle to the second vehicle controller of the towed vehicle through the connector, and performing steering control and reverse driving power control of the towed vehicle based on the reverse signal, the steering angle signal and the reverse driving signal of the towing vehicle, or performing braking control of the towed vehicle based on the braking signal of the towing vehicle, by the second vehicle controller.

In an embodiment, the determining whether the reverse control mode of the towed vehicle is selected may include determining, in a case where an auto hold button of the towing vehicle is pressed for a set time, that the reverse control mode of the towed vehicle is selected by the first vehicle controller, and determining, in a case where the auto hold button of the towing vehicle is pressed again for a set time, that the reverse control mode of the towed vehicle is released by the first vehicle controller.

In another embodiment, the performing the steering control of the towed vehicle by the second vehicle controller may include performing reverse shift of the towed vehicle under the control of a shift controller according to a command of the second vehicle controller, based on the reverse signal of a gearshift transmitted from the first vehicle controller, and performing steering of the towed vehicle under the control of a steering controller according to a command of the second vehicle controller to correspond to a steering angle in reverse of the towing vehicle, based on the steering angle signal of a steering angle sensor transmitted from the first vehicle controller.

In still another embodiment, the performing the reverse driving power control of the towed vehicle by the second vehicle controller may include performing reverse shift of the towed vehicle under the control of a shift controller according to a command of the second vehicle controller, based on the reverse signal of a gearshift transmitted from the first vehicle controller, and then driving a motor of the towed vehicle in a reverse direction by a control signal for reversing of a motor controller according to a command of the second vehicle controller, based on an accelerator depression detection signal of an accelerator position sensor transmitted from the first vehicle controller.

In yet another embodiment, the performing the braking control of the towed vehicle by the second vehicle controller may include operating a brake system of the towed vehicle under the control of a brake controller according to a command of the second vehicle controller, based on a detection signal of a brake position sensor transmitted from the first vehicle controller.

In still yet another embodiment, the method may further include, in a case where the reverse control mode of the towed vehicle is selected, providing an imaging signal of a first rear-view camera of the towing vehicle and a detection signal of a first around-view parking assist sensor to an around-view controller through the first vehicle controller, providing an imaging signal of a second rear-view camera of the towed vehicle and a detection signal of a second around-view parking assist sensor to the around-view controller through the second vehicle controller, the connector, and the first vehicle controller, and displaying an around-view of the towing vehicle and an around-view of the towed vehicle as one integrated view on a display, by the around view controller.

Other aspects and preferred embodiments of the disclosure are discussed infra.

### BRIEF DESCRIPTION OF THE FIGURES

The above and other features of the present disclosure will now be described in detail with reference to certain exemplary embodiments thereof illustrated the accompanying drawings which are given hereinafter by way of illustration only, and thus are not limitative of the present disclosure, and wherein:

FIGS. 1 and 2 are schematic diagrams showing a state where a conventional towing vehicle is towing a towed vehicle in reverse;

FIG. 3 is a diagram showing a control configuration of a reverse control system in a tow mode of an eco-friendly vehicle according to an embodiment of the present disclosure;

FIG. 4 is a flowchart showing a reverse control method in a tow mode of an eco-friendly vehicle according to an embodiment of the present disclosure; and

FIG. 5 is a diagram schematically showing a state where a towing vehicle and a towed vehicle are in reverse by a reverse control method in a tow mode of an eco-friendly vehicle according to an embodiment of the present disclosure.

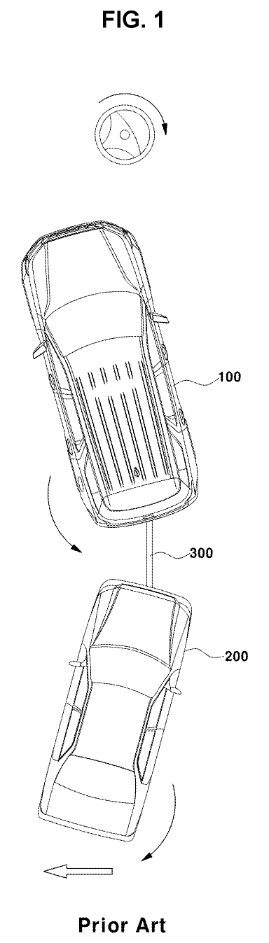

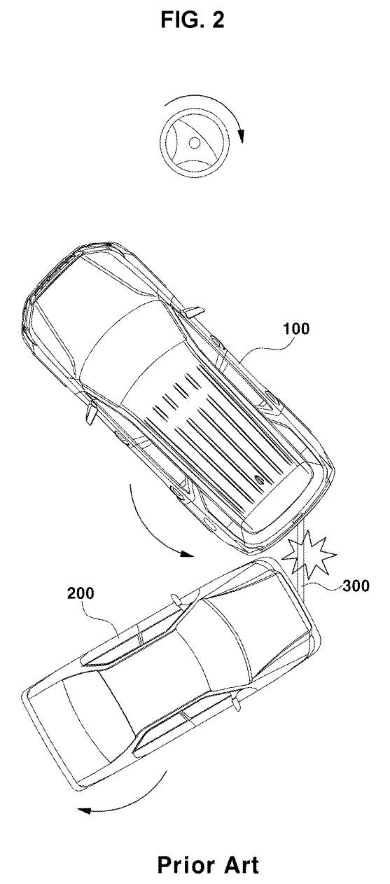

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Specific structural or functional descriptions presented in the embodiments of the present disclosure are merely exemplified for the purpose of describing embodiments according to the concept of the present disclosure, and embodiments according to the concept of the present disclosure may be implemented in various forms. Furthermore, the present disclosure should not be construed as limited to the embodiments described in this specification, but should be understood to include all modifications, equivalents, or substitutes included in the concept and technical scope of the present disclosure.

It will be understood that, although the terms “first”, “second”, etc. may be used herein to describe various elements, these elements should not be limited by these terms. These terms are only used to distinguish one element from another. For example, a first element may be termed a second element, and, similarly, a second element may be termed a first element, without departing from the scope of the exemplary embodiments of the present disclosure.

In addition, it will be understood that, when an element is “connected” or “coupled” to another element, it may be directly connected or coupled to the other element, or may be indirectly connected or coupled to the other element with a different element being interposed therebetween. In contrast, when an element is “directly connected” or “directly coupled” to another element, this means that there is no intervening element therebetween. Other expressions used to describe the relationship between elements should be interpreted in a similar manner (for example, “between” and “directly between”, “adjacent” and “directly adjacent”, etc.).

Wherever possible, the same reference numbers will be used throughout the diagrams to refer to the same or like parts. The terminology used herein is for the purpose of describing particular embodiments only and is not intended to limit embodiments of the disclosure. As used herein, the singular forms “a” and “an” are intended to include the plural forms as well, unless the context clearly indicates otherwise. It will be further understood that the terms “comprise”, “include”, and “have” used herein specify the presence of stated components, steps, operations, and/or elements, but do not preclude the presence or addition of one or more other components, steps, operations, and/or elements.

Hereinafter, embodiments of the present disclosure will be described in detail with reference to the accompanying diagrams.

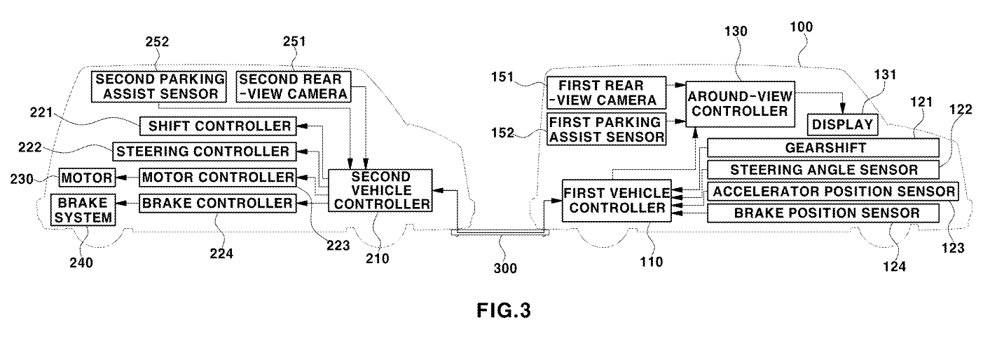

FIG. 3 is a control configuration diagram showing a tow mode control system of an eco-friendly vehicle according to an embodiment of the present disclosure.

As shown in FIG. 3, in order for a towing vehicle 100 to tow a towed vehicle 200 to a destination, the towing vehicle 100 and the towed vehicle 200 may be connected to each other by a connector 300 for towing and communication.

To this end, the towing vehicle 100 and the towed vehicle 200 may be connected to each other by the connector 300, for towing and communication, including a cable for CAN communication, and a first vehicle controller 110 mounted in the towing vehicle 100 and a second vehicle controller 210 mounted in the towed vehicle 200 may be connected to each other to transmit and receive vehicle information for driving by the cable for CAN communication included in the connector 300.

In other words, as the first vehicle controller 110 of the towing vehicle 100 and the second vehicle controller 210 of the towed vehicle 200 each have a communication module (for example, CAN communication module), the first vehicle controller 110 and the second vehicle controller 210 may be connected to each other to transmit and receive vehicle information for driving by the cable for CAN communication contained in the connector 300.

The towing vehicle 100 and the towed vehicle 200 may be motor-driven hybrid vehicles, electric vehicles, or fuel cell vehicles.

In a case where the towing vehicle 100 is towing the towed vehicle 200 to the destination in a state where the towing vehicle 100 and the towed vehicle 200 are connected by the connector 300, a tow charge mode (which may be referred to as an EV flat tow mode) in which regenerative braking of a motor mounted in the towed vehicle 200 is performed and a high voltage battery is charged using power generated by the regenerative braking through an inverter may be performed.

Since steering control and reverse driving power control of the towed vehicle are performed in a case where the towing vehicle is in reverse by reverse driving power during steering in a state where the towing vehicle 100 and the towed vehicle 200 are connected to each other by the connector for towing and communication, it is possible to achieve smooth reversing of the towing vehicle and the towed vehicle and to prevent the connector from being broken or damaged.

To this end, the first vehicle controller 110 is configured to transmit a braking signal, a reverse signal, a steering angle signal and a reverse driving signal of the towing vehicle 100 to the second vehicle controller 210 through the connector 300, and the second vehicle controller 210 is configured to perform the steering control and reverse driving power control of the towed vehicle 200 based on the reverse signal, the steering angle signal and the reverse driving signal of the towing vehicle 100 or to perform braking control of the towed vehicle 200 based on the braking signal of the towing vehicle 100.

Here, in a case where a reverse gear of a gearshift 121 of the towing vehicle is operated, the reverse signal of the towing vehicle may be provided to the first vehicle controller 110, the steering angle signal of the towing vehicle detected by a steering angle sensor 122 of the towing vehicle may be provided to the first vehicle controller 110, the reverse driving signal of the towing vehicle, which is an accelerator depression detection signal, detected by an accelerator position sensor 123 of the towing vehicle, may be provided to the first vehicle controller 110, and the braking signal of the towing vehicle detected by a brake position sensor 124 of the towing vehicle may be provided to the first vehicle controller 110.

Accordingly, the first vehicle controller 110 may transmit the braking signal of the towing vehicle 100 provided by the brake position sensor 124, the reverse signal provided by the gearshift 121, the steering angle signal provided by the steering angle sensor 122, and the reverse driving signal provided by the accelerator position sensor 123 to the second vehicle controller 210 through the connector 300.

The towed vehicle 200 is provided with a shift controller 221 that controls a reverse gear of the towed vehicle according to a command of the second vehicle controller 210, a steering controller 222 that controls a steering angle of the towed vehicle according to a command of the second vehicle controller 210, a motor controller 223 that applies a control signal for reverse driving of the towed vehicle to a motor 230 according to a command of the second vehicle controller 210, and a brake controller 224 that operates a brake system 240 of the towed vehicle according to a command of the second vehicle controller 210.

Accordingly, the second vehicle controller 210 may be configured to transmit a reverse shift signal of the towed vehicle 200 to the shift controller 221 based on the reverse signal of the gearshift 121 transmitted from the first vehicle controller 110, and thus, the reverse shift of the towed vehicle 200 may be achieved under the control of the shift controller 221 during reverse shift of the towing vehicle 100.

In addition, the second vehicle controller 210 may be configured to transmit a steering angle signal corresponding to the steering angle of the towing vehicle in reverse to the steering controller 222 based on the steering angle signal of the steering angle sensor 122 transmitted from the first vehicle controller 110, and thus, the steering angle of the towed vehicle 200 may be adjusted to have a direction and an angle corresponding to the steering angle of the towing vehicle 100 under the control of the steering controller 222.

Further, the second vehicle controller 210 may be configured to transmit a control signal for reversing of the towed vehicle 200 to the motor controller 223 based on the accelerator depression detection signal of the accelerator position sensor 123 transmitted from the first vehicle controller 110. Thus, as the motor 230 is driven in a reversing direction in proportion to the accelerator depression detection signal of the accelerator position sensor 123 according to the control signal of the motor controller 223, the reversing of the towed vehicle 200 is performed with the reversing of the towing vehicle 100.

In addition, the second vehicle controller 210 may be configured to transmit a braking command signal of the towed vehicle 200 to the brake controller 224 based on a detection signal of the brake position sensor 124 transmitted from the first vehicle controller 110, and thus, braking of the towed vehicle 200 may be achieved under the control of the brake controller 224 during braking of the towing vehicle 100.

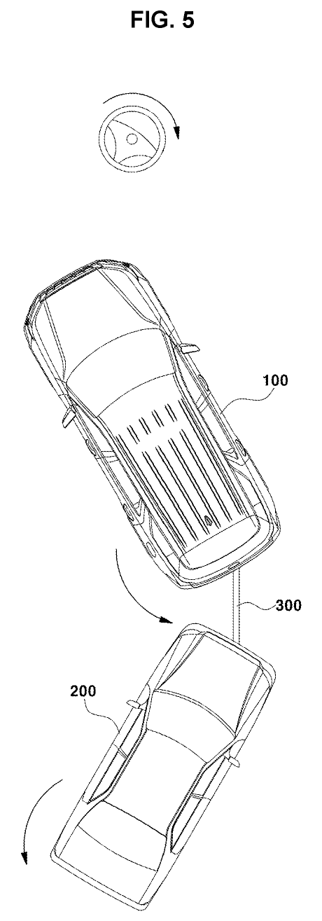

In this way, since the same steering angle control and reverse driving power control as in the towing vehicle 100 is performed for the towed vehicle 200 in a case where the towing vehicle 100 is in reverse by reverse driving power during steering in a state where the towing vehicle 100 and the towed vehicle 200 are connected to each other by the connector 300 for towing and communication, a rear part of the towing vehicle 100 and a rear part of the towed vehicle 200 can move in the same rotating direction and along the same trajectory, as shown in FIG. 5, and accordingly, a driver of the towing vehicle 100 can intuitively recognize the reversing movement of the towed vehicle 200, thereby facilitating smooth reversing, and preventing the connector 300 connected between the towing vehicle 100 and the towed vehicle 200 from being broken or damaged.

On the other hand, the tow mode control system of the eco-friendly vehicle according to the present embodiment may be configured to include a first rear-view camera 151 and a first around-view (i.e., surrounding view) parking assist sensor 152 provided in the towing vehicle 100, a second rear-view camera 251 and a second around-view parking assist sensor 252 provided in the towed vehicle 200, and an around-view controller 130 configured to display an around-view of the towing vehicle 100 and an around-view of the towed vehicle 200 as one integrated view on a display 131.

Here, an imaging signal of the first rear-view camera 151 obtained by imaging a rear view of the towing vehicle 100 and a detection signal of the first around-view parking assist sensor 152 obtained by detecting an obstacle within a certain distance from the front and both sides of the towing vehicle 100 may be provided to the around-view controller 130 through the first vehicle controller 110.

In addition, an imaging signal of the second rear-view camera 251 obtained by imaging a rear view of the towed vehicle 200 and a detection signal of the second around-view parking assist sensor 252 obtained by detecting an obstacle within a certain distance from the front and both sides of the towed vehicle 200 may be provided to the around-view controller 130 through the second vehicle controller 210, the connector 300, and the first vehicle controller 110.

Thus, the around-view of the towing vehicle 100 obtained through the imaging signal of the first rear-view camera 151 and the detection signal of the first around-view parking assist sensor 152, and the around-view of the towed vehicle obtained through the imaging signal of the second rear-view camera 251 and the detection signal of the second around-view parking assist sensor 252 may be displayed as one integrated view on the display 131 of the towing vehicle 100 by the around-view controller 130.

In this way, in a case where the towing vehicle 100 is in reverse by reverse driving power during steering in a state where the towing vehicle 100 and the towed vehicle 200 are connected to each other by the connector 300 for towing and communication, as the integrated view of the around-view of the towing vehicle 100 and the around-view of the towed vehicle 200 is displayed on the display 131, it is possible for the driver of the towing vehicle 100 to visually recognize the reversing movement of the towed vehicle 200 to thereby achieve smooth reversing.

Hereinafter, the reverse control method in the tow mode of the eco-friendly vehicle according to the present embodiment will be described.

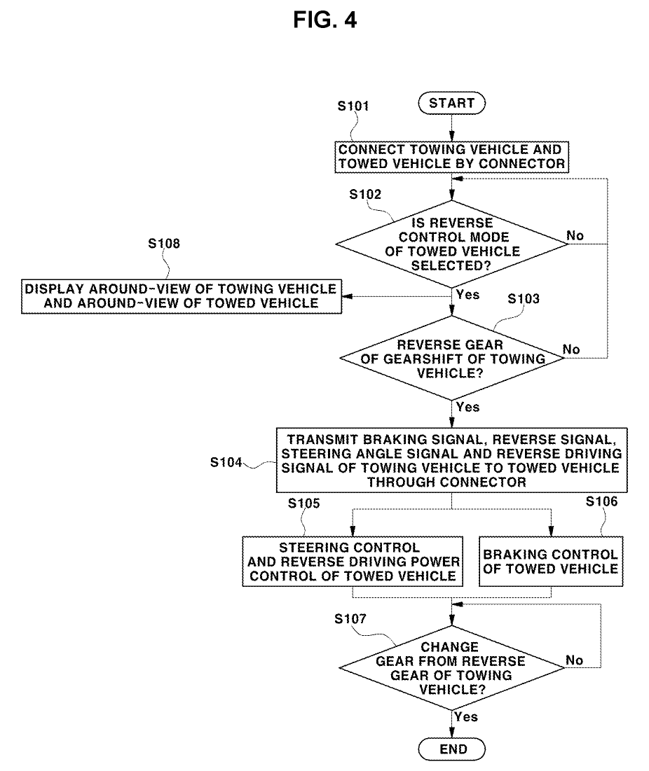

FIG. 4 is a flowchart of a reverse control method in a tow mode of an eco-friendly vehicle according to an embodiment of the present disclosure.

First, in order to activate a tow charge mode (EV flat tow mode) or the like, the towing vehicle 100 and the towed vehicle 200 are connected to each other for towing and communication using the connector 300 including a CAN communication line (S101).

Then, the first vehicle control 110 of the towing vehicle 100 determines whether a reverse control mode of the towed vehicle 200 is selected (S102).

To this end, the towing vehicle 100 may be provided with an auto hold button 140 that outputs a selection signal or a release signal of the reverse control mode of the towed vehicle to the first vehicle controller 110 in a case where the auto hold button 140 is pressed for a set time.

Accordingly, in determining whether the reverse control mode of the towed vehicle 200 is selected, the first vehicle controller 110 may determine that the reverse control mode of the towed vehicle is selected in a case where the auto hold button 140 of the towing vehicle 100 is pressed for the set time, and may determine that the reverse control mode of the towed vehicle is released in a case where the auto hold button 140 is pressed again for a set time.

Subsequently, in selecting the reverse control mode of the towed vehicle, it is determined whether the towing vehicle 100 is in reverse or not (S103).

In a case where a reverse gear of the gearshift 121 of the towing vehicle is operated, as a reverse signal of the towing vehicle is provided to the first vehicle controller 110, the first vehicle controller 110 may determine that the towing vehicle 100 is in a reversible state.

Thus, in selecting the reverse control mode of the towed vehicle, in a case where the reverse signal of the towing vehicle is provided to the first vehicle controller 110 while the reverse gear of the gearshift 121 is operated, a braking signal, a reverse signal, a steering angle signal and a reverse driving signal of the towing vehicle is transmitted from the first vehicle controller 110 to the second vehicle controller 210 of the towed vehicle 200 through the connector 300 (S104).

Here, in a case where the reverse gear of the gearshift 121 of the towing vehicle is operated, the reverse signal of the towing vehicle may be provided to the first vehicle controller 110, the steering angle signal of the towing vehicle detected by the steering angle sensor 122 of the towing vehicle may be provided to the first vehicle controller 110, the reverse driving signal of the towing vehicle, which is an accelerator depression detection signal, detected by the accelerator position sensor 123 of the towing vehicle, may be provided to the first vehicle controller 110, and the braking signal of the towing vehicle detected by the brake position sensor 124 of the towing vehicle may be provided to the first vehicle controller 110.

Accordingly, the first vehicle controller 110 may transmit the braking signal of the towing vehicle 100 from the brake position sensor 124, the reverse signal from the gearshift 121, the steering angle signal from the steering angle sensor 122, and the reverse driving signal from the accelerator position sensor 123 to the second vehicle controller 210 through the connector 300.

Then, steering control and reverse driving power control of the towed vehicle is performed by the second vehicle controller 210, based on the reverse signal, the steering angle signal and the reverse driving signal of the towing vehicle 100 (S105).

The step of performing the steering control of the towed vehicle 200 by the second vehicle controller 210 may include performing reverse shift of the towed vehicle 200 under the control of the shift controller 221 according to a command of the second vehicle controller 210 based on the reverse signal of the gearshift 121 transmitted from the first vehicle controller 110, and then, performing steering of the towed vehicle 200 under the control of the steering controller 222 according to a command of the second vehicle controller 210 based on the steering angle signal of the steering angle sensor 122 transmitted from the first vehicle controller 110 to have a direction and an angle corresponding to the steering angle of the towing vehicle in reverse.

The step of performing the reverse driving power control of the towed vehicle by the second vehicle controller 210 may include performing the reverse shift of the towed vehicle under the control of the shift controller 221 according to a command of the second vehicle controller 210 based on the reverse signal of the gearshift 121 transmitted from the first vehicle controller 110, and then, driving the motor 230 of the towed vehicle 200 in a reverse direction by the reverse driving power control of the motor controller 223 according to a command of the second vehicle controller 210 based on the accelerator depression detection signal of the accelerator position sensor 123 transmitted from the first vehicle controller 110.

In this way, since the same steering angle control and reverse driving power control as in the towing vehicle 100 is performed for the towed vehicle 200 in a case where the towing vehicle 100 is in reverse by reverse driving power during steering, a rear part of the towing vehicle 100 and a rear part of the towed vehicle 200 can move in the same rotating direction and along the same trajectory, as shown in FIG. 5, and accordingly, a driver of the towing vehicle 100 can intuitively recognize the reversing movement of the towed vehicle 200, thereby facilitating smooth reversing, and preventing the connector 300 connected between the towing vehicle 100 and the towed vehicle 200 from being broken or damaged.

Here, the braking control of the towed vehicle may be performed together with the braking control of the towing vehicle.

To this end, based on the braking signal of the towing vehicle 100, the braking control of the towed vehicle 200 is performed by the second vehicle controller 210 (S106).

In the step of performing the braking control of the towed vehicle 200, the brake system 240 of the towed vehicle 200 may be operated under the control of the brake controller 224 according to a command of the second vehicle controller 210 based on the detection signal of the brake position sensor 124 transmitted from the first vehicle controller 110.

In addition, in a case where the reverse control mode of the towed vehicle is selected, a step of providing an imaging signal of the first rear-view camera 151 of the towing vehicle 100 and a detection signal of the first around-view parking assist sensor 152 to the around-view controller 130 through the first vehicle controller 110, a step of providing an imaging signal of the second rear-view camera 251 of the towed vehicle 200 and a detection signal of the second around-view parking assist sensor 252 to the around-view controller 130 through the second vehicle controller 210, the connector 300, and the first vehicle controller 110, and a step of displaying an around-view of the towing vehicle 100 and an around-view of the towed vehicle 200 as one integrated view on the display 131, by the around-view controller 130, may be further performed.

Here, an imaging signal of the first rear-view camera 151 obtained by imaging a rear view of the towing vehicle 100 and a detection signal of the first around-view parking assist sensor 152 obtained by detecting an obstacle within a certain distance from the front and both sides of the towing vehicle 100 may be provided to the around-view controller 130 through the first vehicle controller 110, and an imaging signal of the second rear-view camera 251 obtained by imaging a rear view of the towed vehicle 200 and a detection signal of the second around-view parking assist sensor 252 obtained by detecting an obstacle within a certain distance from the front and both sides of the towed vehicle 200 may be provided to the around-view controller 130 through the second vehicle controller 210, the connector 300, and the first vehicle controller 110.

Thus, the around-view of the towing vehicle 100 obtained through the imaging signal of the first rear-view camera 151 and the detection signal of the first around-view parking assist sensor 152, and the around-view of the towed vehicle 200 obtained through the imaging signal of the second rear-view camera 251 and the detection signal of the second around-view parking assist sensor 252 may be displayed as one integrated view on the display 131 of the towing vehicle 100 by the around-view controller 130.

In this way, in a case where the towing vehicle 100 is in reverse by reverse driving power during steering in a state where the towing vehicle 100 and the towed vehicle 200 are connected to each other by the connector 300 for towing and communication, as the integrated view of the around-view of the towing vehicle 100 and the around-view of the towed vehicle 200 is displayed on the display 131, it is possible for the driver of the towing vehicle 100 to visually recognize the reversing movement of the towed vehicle 200 to thereby achieve smooth reversing.

In addition, in a case where the steering control and the reverse driving power control of the towed vehicle is performed in step S105, or in a case where the braking control of the towed vehicle is performed in step S106, the first vehicle controller 110 determines whether the towing vehicle changes gears (S107). In a case where it is determined that the towing vehicle changes gears from reverse gear to drive gear, the reverse control mode of the towed vehicle is terminated.

According to the present disclosure, the following effects are achieved.

First, since steering control and reverse driving power control of the towed vehicle is performed in a case where the towing vehicle is in reverse by reverse driving power during steering in a state where the towing vehicle and the towed vehicle are connected to each other by the connector for towing and communication, a driver of the towing vehicle can intuitively control the reversing movement of the towed vehicle, thereby facilitating smooth reversing of the towing vehicle and the towed vehicle.

Second, since the steering control and the reverse driving power control of the towed vehicle is performed in a case where the towing vehicle is in reverse by reverse driving power during steering in a state where the towing vehicle and the towed vehicle are connected to each other by the connector for towing and communication, it is possible to move a rear part of the towing vehicle and a rear part of the towed vehicle in the same rotating direction and along the same trajectory, thereby preventing the connector connected between the towing vehicle and the towed vehicle from being broken or damaged.

The disclosure has been described in detail with reference to embodiments thereof. However, it will be appreciated by those skilled in the art that changes may be made in these embodiments without departing from the principles and spirit of the disclosure, the scope of which is defined in the appended claims and their equivalents.

1. A reverse control system in a tow mode of an eco-friendly vehicle, comprising:
a first vehicle controller mounted in a towing vehicle;
a second vehicle controller mounted in a towed vehicle; and
a connector connected between the towing vehicle and the towed vehicle, and configured to allow towing and communication;
wherein the first vehicle controller is configured to transmit a braking signal, a reverse signal, a steering angle signal and a reverse driving signal of the towing vehicle to the second vehicle controller through the connector; and
wherein the second vehicle controller is configured to perform steering control and reverse driving power control of the towed vehicle based on the reverse signal, the steering angle signal and the reverse driving signal of the towing vehicle, or to perform braking control of the towed vehicle based on the braking signal of the towing vehicle.

2. The system according to claim 1, further comprising:
a gearshift configured to provide the reverse signal of the towing vehicle to the first vehicle controller;
a steering angle sensor configured to provide the steering angle signal of the towing vehicle to the first vehicle controller;
an accelerator position sensor configured to provide the reverse driving signal of the towing vehicle to the first vehicle controller;
a brake position sensor configured to provide the braking signal of the towing vehicle to the first vehicle controller;
a shift controller configured to control a reverse gear of the towed vehicle according to a command of the second vehicle controller;
a steering controller configured to control a steering angle of the towed vehicle according to a command of the second vehicle controller;
a motor controller configured to apply a reverse driving power of the towed vehicle to a motor according to a command of the second vehicle controller; and
a brake controller configured to operate a brake system of the towed vehicle according to a command of the second vehicle controller.

3. The system according to claim 2, wherein the second vehicle controller is configured to transmit a reverse shift of the towed vehicle to the shift controller based on the reverse signal of the gearshift transmitted from the first vehicle controller.

4. The system according to claim 2, wherein the second vehicle controller is configured to transmit a steering angle signal corresponding to the steering angle in reverse of the towing vehicle to the steering controller based on the steering angle signal of the steering angle sensor transmitted from the first vehicle controller.

5. The system according to claim 2, wherein the second vehicle controller is configured to transmit a control signal for reversing of the towed vehicle to the motor controller based on an accelerator depression detection signal of the accelerator position sensor transmitted from the first vehicle controller.

6. The system according to claim 2, wherein the second vehicle controller is configured to transmit a braking command signal of the towed vehicle to the brake controller based on a detection signal of the brake position sensor transmitted from the first vehicle controller.

7. The system according to claim 1, further comprising:
a first rear-view camera and a first around-view parking assist sensor positioned in the towing vehicle;
a second rear-view camera and a second around-view parking assist sensor positioned in the towed vehicle; and
an around-view controller configured to receive an imaging signal from the first rear-view camera, to receive a detection signal from the first around-view parking assist sensor through the first vehicle controller, to receive an imaging signal from the second rear-view camera, and to receive a detection signal from the second around-view parking assist sensor through the second vehicle controller, the connector, and the first vehicle controller, to display an around-view of the towing vehicle and an around-view of the towed vehicle as one integrated view on a display.

8. The system according to claim 1, further comprising:
an auto hold button configured to output a select signal or a release signal of a reverse control mode of the towed vehicle to the first vehicle controller when pressed for a set time.

9. The system according to claim 8, wherein when the first vehicle controller determines that the towing vehicle changes gears from a reverse gear to a drive gear, the first vehicle controller is configured to terminate the reverse control mode of the towed vehicle.

10. A reverse control method in a tow mode of an eco-friendly vehicle, comprising:
connecting a towing vehicle and a towed vehicle for towing and communication, by a connector;
determining whether a reverse control mode of the towed vehicle is selected by a first vehicle controller of the towing vehicle;
transmitting, when the reverse control mode of the towed vehicle is selected, a braking signal, a reverse signal, a steering angle signal and a reverse driving signal of the towing vehicle from the first vehicle controller of the towing vehicle to a second vehicle controller of the towed vehicle through the connector; and
performing steering control and reverse driving power control of the towed vehicle based on the reverse signal, the steering angle signal and the reverse driving signal of the towing vehicle, or performing braking control of the towed vehicle based on the braking signal of the towing vehicle, by the second vehicle controller.

11. The method according to claim 10, wherein the determining whether the reverse control mode of the towed vehicle is selected comprises: determining, when an auto hold button of the towing vehicle is pressed for a set time, that the reverse control mode of the towed vehicle is selected by the first vehicle controller, and determining, when the auto hold button of the towing vehicle is pressed again for a set time, that the reverse control mode of the towed vehicle is released by the first vehicle controller.

12. The method according to claim 10, wherein the performing the steering control of the towed vehicle by the second vehicle controller comprises:
performing reverse shift of the towed vehicle by a shift controller according to a command of the second vehicle controller, based on the reverse signal of a gearshift transmitted from the first vehicle controller; and
performing steering of the towed vehicle by a steering controller according to a command of the second vehicle controller to correspond to a steering angle in reverse of the towing vehicle, based on the steering angle signal of a steering angle sensor transmitted from the first vehicle controller.

13. The method according to claim 10, wherein the performing the reverse driving power control of the towed vehicle by the second vehicle controller comprises:
performing reverse shift of the towed vehicle by a shift controller according to a command of the second vehicle controller, based on the reverse signal of a gearshift transmitted from the first vehicle controller; and then
driving a motor of the towed vehicle in a reverse direction by a control signal for reversing of a motor controller according to a command of the second vehicle controller, based on an accelerator depression detection signal of an accelerator position sensor transmitted from the first vehicle controller.

14. The method according to claim 10, wherein the performing the braking control of the towed vehicle by the second vehicle controller comprises:
operating a brake system of the towed vehicle under the control of a brake controller according to a command of the second vehicle controller, based on a detection signal of a brake position sensor transmitted from the first vehicle controller.

15. The method according to claim 10, further comprising:
when the reverse control mode of the towed vehicle is selected,
providing an imaging signal of a first rear-view camera of the towing vehicle and a detection signal of a first around-view parking assist sensor to an around-view controller through the first vehicle controller;
providing an imaging signal of a second rear-view camera of the towed vehicle and a detection signal of a second around-view parking assist sensor to the around-view controller through the second vehicle controller, the connector, and the first vehicle controller; and
displaying an around-view of the towing vehicle and an around-view of the towed vehicle as one integrated view on a display, by the around-view controller.

16. The method according to claim 10, further comprising terminating the reverse control mode of the towed vehicle when the first controller determines that the towing vehicle changes gears from a reverse gear to a drive gear.
